(19) United States
(12) Patent Application Publication
(10) Pub. No.: US 2004/0239531 A1
(43) Pub. Date: Dec. 2, 2004

(54) Systems and methods for providing traffic alerts

(76) Inventor: Maria Adamczyk, Alpharetta, GA (US)

Correspondence Address: KIRKPATRICK & LOCKHART LLP, 535 SMITHFIELD STREET, PITTSBURGH, PA, 15222, US

(21) Appl. No.: 10/447,030

(22) Filed: May 28, 2003

(51) Int. Cl. G08G 1/123

(52) U.S. Cl. 340/995.13

(57) ABSTRACT

A traffic alert system. The system includes a database having stored thereon a profile relating to a user of a mobile device. The system also includes a server, wherein the server is configured to receive traffic information relating to a route and location information relating to the mobile device, and wherein the server is configured to send a traffic alert to the mobile device when the traffic information and the location information indicate that the mobile device is traveling toward traffic congestion.

### BACKGROUND

The present invention relates generally to systems and methods for providing traffic alerts.

Navigational and position-finding devices have become popular in recent years. Such devices are typically used by aviators, boaters, outdoorsmen, and persons navigating unfamiliar streets in an automobile. The devices typically use global positioning system (GPS) technology to determine the position (e.g. in latitude and longitude) of the device and, in some cases, the altitude of the device. GPS technology is likewise becoming increasingly prevalent in wireless devices, such as wireless or cellular telephones. Because such navigational and position-finding devices and wireless devices are increasingly being used in automobiles and trucks, such devices have the potential to receive real-time alerts as to traffic conditions that a driver may use to plan a route of travel or to avoid an area that has traffic congestion due to, for example, an accident or dangerous driving conditions due to inclement weather.

### SUMMARY

In one embodiment, the present invention is directed to a traffic alert system. The system includes a database having stored thereon a profile relating to a user of a mobile device. The system also includes a server, wherein the server is configured to receive traffic information relating to a route and location information relating to the mobile device, and wherein the server is configured to send a traffic alert to the mobile device when the traffic information and the location information indicate that the mobile device is traveling toward traffic congestion.

In one embodiment, the present invention is directed to a system. The system includes a location server having location information relating to a mobile device and a traffic server having traffic information relating to traffic conditions on a route. The system also includes a traffic alert system in communication with the location server and the traffic server, wherein the traffic alert system includes a database having stored thereon a profile relating to a user of the mobile device and a server, wherein the server is configured to receive the traffic information and the location information, and wherein the server is configured to send a traffic alert to the mobile device when the traffic information and the location information indicate that the mobile device is traveling toward traffic congestion.

In one embodiment, the present invention is directed to a method of providing a traffic alert to a mobile device. The method includes monitoring traffic alert information and determining whether the traffic alert is possible based on the traffic alert information and a user profile. The method also includes retrieving a location of the mobile device, determining whether an alert is necessary based on the location of the mobile device and the traffic alert information, and providing the alert to the mobile device when the alert is necessary.

### BRIEF DESCRIPTION OF THE DRAWINGS

Further advantages of the present invention may be better understood by referring to the following description taken in conjunction with the accompanying drawings, in which:

FIG. 1 is a diagram illustrating a system according to one embodiment of the present invention;

FIG. 2 is a diagram illustrating an example of traffic data that may be retrieved from a traffic server according to one embodiment of the present invention; and

FIG. 3 is a diagram illustrating a process of providing traffic alerts according to one embodiment of the present invention.

### DESCRIPTION

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein.

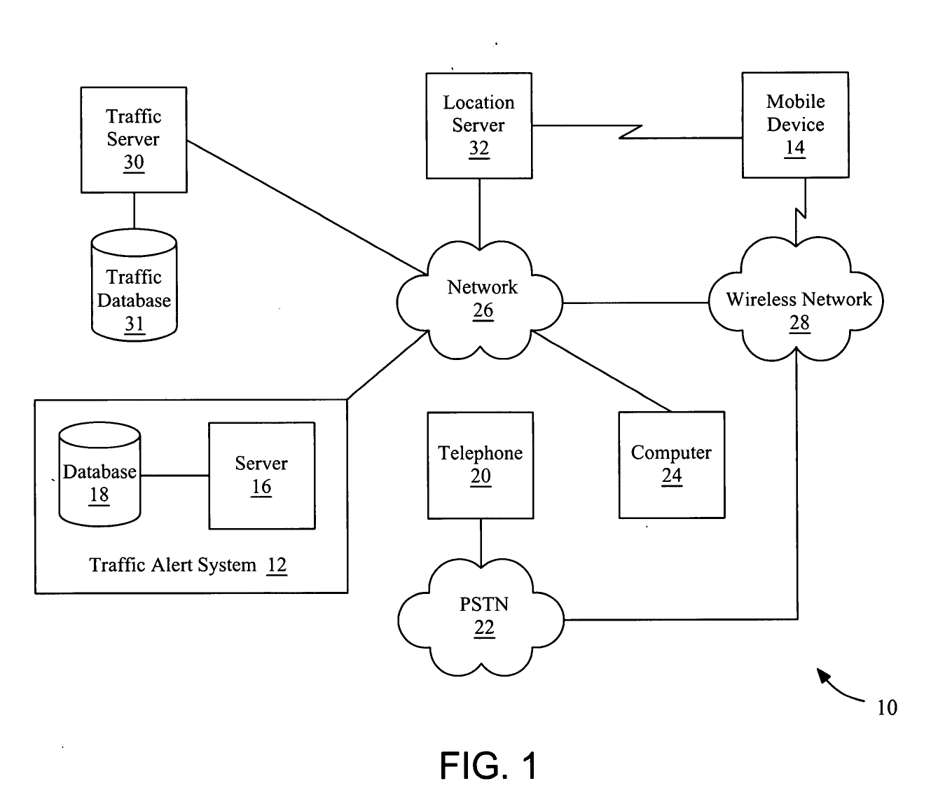

FIG. 1 is a diagram illustrating a system 10 according to one embodiment of the present invention. The system 10 includes a traffic alert system 12 that determines when alerts are to be transmitted to a customer, or subscriber, of a traffic alert service. A traffic alert may be issued by the traffic alert system 12 when, for example, a planned or intended route of travel on which a motorist is traveling or intends to travel is obstructed or congested due to, for example, an accident, road maintenance or construction work, or adverse or inclement weather conditions. The traffic alert system 12 may also maintain a profile of a user, or a subscriber, that is entitled to receive traffic alerts via a mobile device 14. The mobile device 14 may be any type of voice or data device that is capable of providing communications capability. Examples of mobile devices are wireless (e.g. cellular) telephones, one and two-way pagers, in-vehicle GPS or navigation devices, wireless electronic mail devices, and any other type of communication device.

The traffic alert system 12 includes a server 16 and a database 18. The database 18 may store information relating to, for example, a user or a subscriber that is entitled to receive traffic alerts via the mobile device 14. For example, the database 18 may store the approximate times that the user or subscriber commutes to, for example, work in the morning and afternoon, the preferred route or routes that the user or subscriber takes, the type(s) of mobile devices with which the user or subscriber would prefer to receive traffic alerts, a wireline telephone number of the user or subscriber, and the telephone number or address of the preferred mobile device(s). The traffic alert server 16 may allow the user or subscriber to update, change, or add information to the database 18 via, for example, a telephone 20 that is in communication with the traffic alert system 12 via, for example, the public switched telephone network (PSTN) 22, via a computer 24 that is in communication with the traffic alert system 12 via, for example, a network 26 such as the Internet, or via the mobile device 14 via, for example, a wireless network 28, such as a cellular telephone network or a GPS network, and the PSTN 22 with the traffic alert system 12.

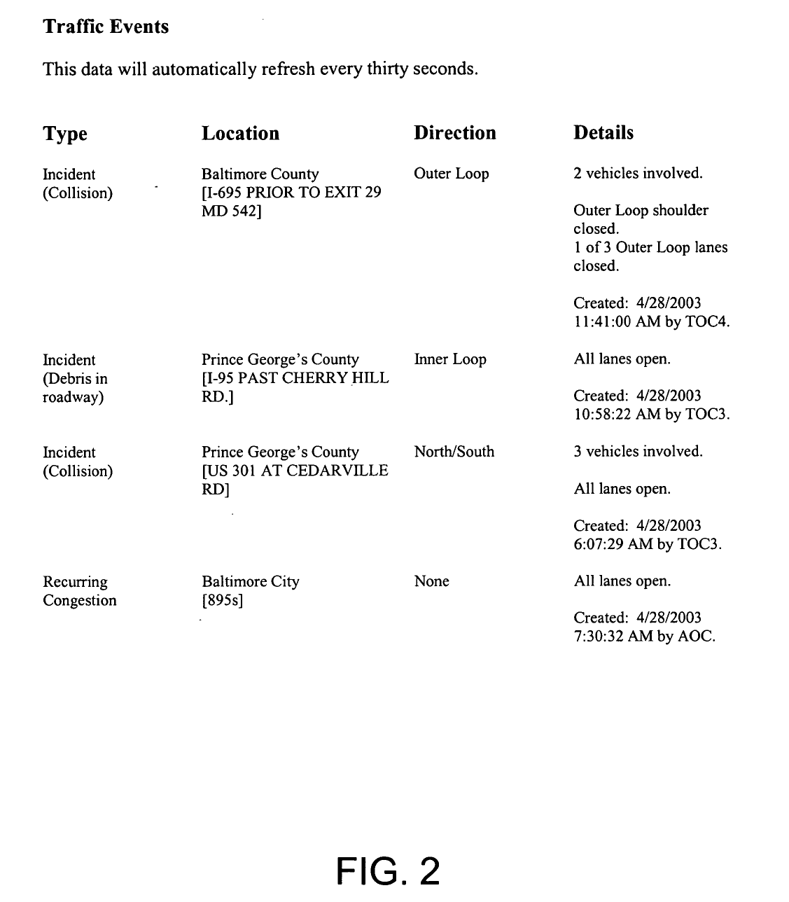

A traffic server 30 is in communication with the traffic alert system 12 via the network 26. The traffic server 30 may be, for example, a web server that is maintained by, for example, a state transportation department, a police department or similar law enforcement agency, or a public works department. The traffic server 30 may include or be in communication with, for example, a traffic database 31 that includes information relating to traffic accidents and traffic congestion on various roadways that are located within the jurisdiction of the owner or operator of the traffic server 30. The traffic information from the traffic server 30 may be requested from the server 16 and transmitted by the traffic server 30 in, for example, html format. An example of such a server is operated by the Maryland Coordinated Highways Action Response Team and can be found at the Internet world wide web address: www.chart.state.md.us/TravInfo/trafficEvents.asp. FIG. 2 is a diagram illustrating an example of traffic data that may be retrieved from the aforementioned address.

A location server 32 determines the location of the mobile device 14. For example, the location server may determine the location of the mobile device 14 using a GPS position of the mobile device 14, using a triangulation technique (e.g. time difference of arrival (TDOA)), using a positioning technique such as that used by an E911 service, or using an automatic location information system. The location server 32 may also determine the direction of travel and/or the speed of travel of the mobile device 14 using at least two location points.

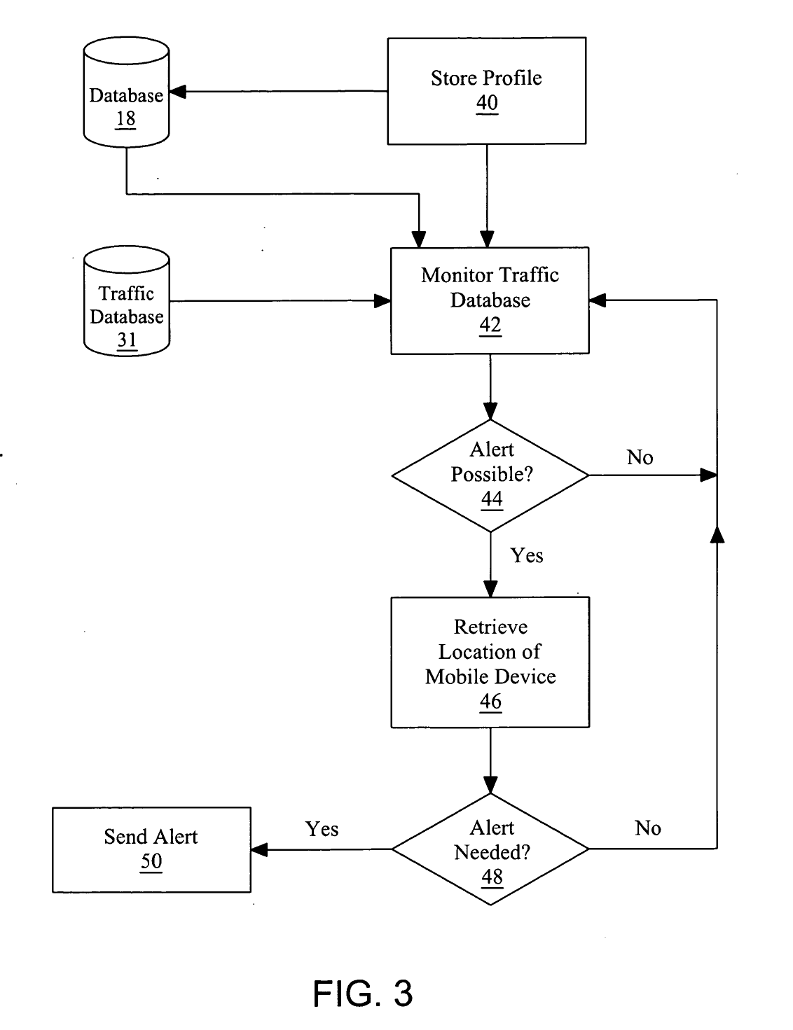

FIG. 3 is a diagram illustrating a process of providing traffic alerts according to one embodiment of the present invention. According to one embodiment of the present invention, the process illustrated in FIG. 3 may be performed by the traffic alert system 12. At step 40, a profile is stored in the database 18 that may include, for example, data relating to travel routes and re-occurring travel times, with the traffic alert system 12 using either the telephone 20, the computer 24, or the mobile device 14. At step 40, the traffic database 31 is monitored by, for example, requesting information via the traffic server 30 relating to traffic information for the route or routes that a user or subscriber may follow. At step 44, the process determines if an alert may need to be sent to the mobile device 14. For example, if the data retrieved from the traffic database 31 indicate that an accident is hindering traffic on a road that a user or subscriber has indicated on a profile as being on a travel route, an alert is possible.

If the data from the traffic database 31 do not indicate that an alert is possible, the process returns to step 42 to monitor the data for further alerts. If the data from the traffic database 31 indicate that an alert is possible, the process advances to step 46 where the process determines, by querying the location server 32, where the mobile device 14 is located and/or the direction of travel of the mobile device 14.

Based on the position and/or the direction of travel of the mobile device 14, the process determines at step 48 whether an alert is needed. For example, if the mobile device 14 is located in proximity to a traffic accident that is causing congestion and/or if the mobile device 14 is traveling in the direction of the traffic congestion, an alert to the mobile device 14 is appropriate. If no alert is needed, the process returns to step 42 to monitor the data from the traffic database 31 for further alerts. If an alert is needed, the process advances to step 50, where an alert is sent to the mobile device 14. In one embodiment, the process determines whether the mobile device 14 is within a predetermined distance (e.g. 5 miles) from the source of the traffic congestion. In one embodiment, the predetermined distance is specified by the subscriber of the user in the profile that is stored in the database 18.

The alert may be sent in an appropriate format that can be received by the mobile device 14. For example, if the mobile device 14 is a wireless telephone, the alert may be sent as a telephone call or as a short message service (SMS) message or multimedia message service (MMS) message. If the mobile device 14 is an in-vehicle GPS navigation system, the message may be sent via satellite as a message to be displayed on the console or display device of the in-vehicle device. The alert may include information relating to the source and location of the traffic congestion and may include information relating to an alternate route that may be taken by the user of subscriber.

It can be understood that the processes and procedures described herein may be operated as, for example, a subscription-based service by, for example, a telecommunications service provider, a telecommunications network owner or operator, or as a separate service.

The term “computer-readable medium” as used herein may include, for example, magnetic and optical memory devices such as diskettes, compact discs of both read-only and writeable varieties, optical disk drives, and hard disk drives. A computer-readable medium may also include memory storage that can be physical, virtual, permanent, temporary, semi-permanent and/or semi-temporary. A computer-readable medium may further include one or more data signals transmitted on one or more carrier waves.

The various portions and components of various embodiments of the present invention can be implemented in computer software code using, for example, Visual Basic, C, or C++ computer languages using, for example, object-oriented techniques.

While several embodiments of the invention have been described, it should be apparent, however, that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

What is claimed is:

1. A traffic alert system, comprising:
a database having stored thereon a profile relating to a user of a mobile device; and
a server, wherein the server is configured to receive traffic information relating to a route and location information relating to the mobile device, and wherein the server is configured to send a traffic alert to the mobile device when the traffic information and the location information indicate that the mobile device is traveling toward traffic congestion.

2. The system of claim 1, wherein the profile includes information concerning at least one of a device address of the mobile device, a telephone number of the mobile device, a commute time, and a route of travel.

3. The system of claim 1, wherein the mobile device is one of a wireless telephone, a pager, and a navigation device.

4. The system of claim 1, wherein the location information includes a direction of travel of the mobile device.

5. The system of claim 1, wherein the traffic information is obtained from one of a state transportation department, a police department, a law enforcement agency, and a public works department.

6. The system of claim 1, wherein the server is configured to send the traffic alert via one of a computer network and a wireless network.

7. A system, comprising:
a location server having location information relating to a mobile device;
a traffic server having traffic information relating to traffic conditions on a route; and
a traffic alert system in communication with the location server and the traffic server, wherein the traffic alert system includes:
a database having stored thereon a profile relating to a user of the mobile device; and
a server, wherein the server is configured to receive the traffic information and the location information, and wherein the server is configured to send a traffic alert to the mobile device when the traffic information and the location information indicate that the mobile device is traveling toward traffic congestion.

8. The system of claim 7, wherein the network includes the Internet.

9. The system of claim 7, further comprising a database in communication with the traffic server.

10. The system of claim 7, wherein the mobile device is in communication with one of a wireless network and a satellite network.

11. The system of claim 7, wherein the mobile device is one of a wireless telephone, a pager, and a navigation device.

12. The system of claim 7, further comprising a telephone in communication with the traffic alert system, wherein the telephone allows the user to configure the profile.

13. The system of claim 12, wherein the telephone is in communication with the traffic alert system via the PSTN.

14. The system of claim 7, further comprising a computer in communication with the traffic alert system, wherein the computer allows the user to configure the profile.

15. The system of claim 14, wherein the computer is in communication with the traffic alert system via the network.

16. A method of providing a traffic alert to a mobile device, comprising:
monitoring traffic alert information;
determining whether the traffic alert is possible based on the traffic alert information and a user profile;
retrieving a location of the mobile device;
determining whether an alert is necessary based on the location of the mobile device and the traffic alert information; and
providing the alert to the mobile device when the alert is necessary.

17. The method of claim 16, further comprising storing the profile in a database.

18. The method of claim 16, wherein monitoring the traffic alert information includes monitoring information provided by one of a state transportation department, a police department, a law enforcement agency, and a public works department.

19. The method of claim 16, wherein providing the alert to the mobile device includes providing the alert via one of a computer network, a wireless network, and a satellite network.

20. The method of claim 16, further comprising determining the location of the mobile device based on one of a GPS location of the mobile device and a triangulated location of the mobile device.
